(19) United States
(12) Patent Application Publication
(10) Pub. No.: US 2019/0337255 A1
(43) Pub. Date: Nov. 7, 2019

(54) SYSTEM FOR TOOL CHANGING IN BENDING PRESSES

(71) Applicant: FASTACHANGE S.R.L., PARMA (IT)

(72) Inventors: Gian Luca TARASCONI, Lesignano De? Bagni (PR) (IT); Vincenzo MORA, Basilicanova (PR) (IT); Massimo MOTTA, Boretto (RE) (IT)

(73) Assignee: FASTACHANGE S.R.L., PARMA (IT)

(21) Appl. No.: 16/479,345

(22) PCT Filed: Jan. 16, 2018
(86) PCT No.: PCT/IB2018/050258

§ 371 Date: Jul. 19, 2019

(30) Foreign Application Priority Data
Jan. 25, 2017 (IT) 102017000007989

(51) Int. Cl. B30B 15/02; B21D 5/02; B21D 37/14

(52) U.S. Cl. CPC B30B 15/028; B21D 37/145; B21D 5/0254

(57) ABSTRACT

A system (10) for tool changing in bending presses (20) comprising: a plurality of bending tools (30) each having a gripping shank (311, 321) configured to be clamped by a bending press (20) and a hook appendix (312,322) distinct from the gripping shank (311,321); a tool-holder bar (50) configured to sustain in a detachable way at least one bending tool (30) by means of the hook appendix (312, 322); and a robotized arm (70) configured to selectively grasp and move a bending tool (30), for loading/unloading a bending tool (30) on/from the tool-holder bar (50), and the tool-holder bar (50), for moving the tool-holder bar (50) nearer to/away from the bending press (20).

### TECHNICAL FIELD

The present invention relates to a system for tool changing in bending presses or press-bending machines.

More specifically, a robotized and automated system for changing a plurality of tools in bending presses.

### PRIOR ART

Press-bending machines are known for bending metal sheets by exerting a pressure action by means of suitable pressing tools, i.e. dies and punches. The metal sheets are inserted into the bending press between at least one die and a punch which impart a certain shape to the imparted bend.

In order to be able to perform different types of bends or in any case when necessary, it is known to change bending tool or change the orientation thereof.

Press-bending machines are known in which the tool changing system provides for the replacement of a tool at a time by means of suitable hooking mechanisms which constrain the other pressing tools to the bending press when it releases them for replacement. Such pressing tools and such press-bending machines of known type are for example described in patents US2009/0217731 and U.S. Pat. No. 6,843,760.

Such press-bending machines have, however, long idle times due to the time of replacement of the various pressing tools (dies and/or punches), they use dedicated pressing tools of considerable cost to the user and require the use of a manipulator which has a high cantering accuracy and precision for the gripping of the pressing tools, but—at the same time—require a high manoeuvring speed for the minimization of idle times (non-operative machine), which for the replacement of many pressing tools can also be about an hour or a few hours.

One object of the present invention is to overcome the above drawbacks of the prior art with a simple, rational and cost-effective solution.

In practice, an object of the present invention is to provide a tool change system for bending presses which is fast, considerably reduces machine downtime, is particularly versatile and can be configured in various ways, being able to use any type of tool and being cost-effective for the user. These objects are achieved by the features of the invention described in the independent claim. The dependent claims describe preferred and/or particularly advantageous aspects of the invention.

### DESCRIPTION OF THE INVENTION

The invention, in particular, provides a system for tool changing in bending presses comprising:
a plurality of bending tools each having a gripping shank configured to be clamped by a bending press and a hook appendix distinct from the gripping shank;
a tool-holder bar configured to sustain in a detachable way at least one bending tool by means of the hook appendix; and
a robotized arm configured to selectively grasp and move a bending tool, for loading/unloading a bending tool on/from the tool-holder bar, and the tool-holder bar, for moving the tool-holder bar nearer to/away from the bending press.

With this solution, it is possible to minimize the idle time related to the tool change, and in particular it is possible to use the working hours of the bending press to configure the new set of bending tools to replace those ones, thus improving time and operation of the replacement of the bending tools.

Moreover, with this solution, the bending tools are all replaced together, i.e. all the punches or all the dies together, making all the safety systems useless, such as the buttons or other devices placed on the bending press and the bending tools, thus allowing a significant saving in the cost of the bending tools.

Moreover, with this solution, the tool changing system is substantially universal or suitable for tool change in any (or most) bending press existing on the market.

One aspect of the present invention provides that the robotized arm can comprise a first gripping part configured to grasp a bending tool at a portion of the same distinct from said hook appendix.

Moreover, the robotized arm can comprise a second gripping part configured to grasp the tool-holder bar.

With such solutions, the same robotized arm can operate a bending tool at a time or an entire pre-determined set of bending tools pre-assembled on the tool-holder bar.

One aspect of the invention, moreover, provides that the tool-holder bar can comprise a retention vice configured to retain the hook appendix of the bending tool, wherein the retention vice is selectively operable between an opening configuration, wherein it frees the hook appendix, and a closing configuration, wherein it retains the hook appendix.

Advantageously, the retention vice of the tool-holder bar can be alternately operable between the opening configuration and the closing configuration by the robotized arm, when the robotized arm is engaged on the tool-holder bar. With this solution, the hooking of the bending tools on the tool-holder bar is particularly safe.

Advantageously, the tool-holder bar can be configured to sustain in a detachable way a plurality of bending tools with the gripping shanks aligned with one another along a longitudinal axis of the tool-holder bar and the hook appendices aligned with one another along the longitudinal axis of the tool-holder bar.

With this solution, a plurality of bending tools can easily be taken over by a tool-holder bar and/or a clamp of a bending press.

A further aspect of the invention provides that the robotized arm can be operatively connected to an electronic control unit configured to perform the following steps:
a first step of loading/unloading one bending tool at a time on/from the tool-holder bar; and
a second step of grasping and moving the tool-holder bar.

With this solution, the tool change is made possible in an automated way using only the robotized arm.

Advantageously, the first step may comprise a step of loading the bending tool comprising the steps of:
picking up one bending tool at a time from a storage magazine of the plurality of bending tools;
positioning the bending tool picked up at a pre-determined axial position of the tool-holder bar; and
releasing the bending tool on the tool-holder bar by means of the mechanical engagement of the hook appendix with the tool-holder bar.

Moreover, the first step may comprise a step of unloading the bending tool comprising the steps of:
picking up one bending tool at a time from a pre-determined axial position of the tool-holder bar;
positioning the bending tool picked up at a pre-determined position of a storage magazine of the plurality of bending tools; and
releasing the bending tool in the storage magazine.

Advantageously, the second step may comprise the steps of:
grasping the tool-holder bar and
moving the tool-holder bar grasped between a loading/unloading position thereof, wherein the tool-holder bar is arranged in a loading station distal from the bending press, and a supply position of the bending press, wherein the tool-holder bar is arranged in the proximity of the bending press with longitudinal axis parallel to a longitudinal axis of the bending press itself for the picking up/release of bending tools from/to the bending press.

A further aspect of the invention provides that the first loading/unloading step can be carried out totally (or at least partially) during a work step of the bending press, wherein the bending press bends a sheet by means of a further bending tool (or a further set of bending tools) clamped by the upper or lower vice thereof.

With this solution, the system allows composing the new set of bending tools to be replaced to the one in use in a hidden time, i.e. an operating time of the bending press, allowing a significant reduction of idle times due to the replacement of the set of bending tools.

A further aspect of the invention provides that the robotized arm can be placed on a conveyor (for example a track motion or a linear conveyor) so as to be able to be moved by the same conveyor alternately among a plurality of bending presses.

With this solution, with a single robotized arm, it is possible to serve, for the tool change, several bending presses, for example using—for the movement and the composition of set of bending tools to be replaced to those used by the various bending presses—the working times of the various bending presses.

### BRIEF DESCRIPTION OF THE DRAWINGS

Further features and advantages of the invention will become apparent from the following description, provided by way of non-limiting example with the aid of the figures shown in the accompanying drawings.

FIG. 1 is an axonometric view of a tool change system in bending presses according to the invention.

FIG. 2 is a top view of FIG. 1.

FIG. 3 is a sectional view of FIG. 1.

FIG. 4 is an enlarged view of detail IV in FIG. 3.

FIG. 5 is a further sectional view of FIG. 1.

FIG. 6 is a sectional view of the tool change system in bending presses according to the invention in a first operating position.

FIG. 7 is a sectional view of the tool change system in bending presses according to the invention in a second operating position.

FIG. 8 is a sectional view of the tool change system in bending presses according to the invention in a third operating position.

FIG. 9 is a sectional view of the tool change system in bending presses according to the invention in a fourth operating position.

FIG. 10 is an axonometric view of a tool-holder bar of the system according to the invention.

FIG. 11 is a front view of FIG. 10.

FIG. 12 is a sectional view along the sectional line XII-XII in FIG. 11.

FIG. 13 is a sectional view of a tool-holder bar of the system according to the invention supporting a die.

FIG. 14 is an axonometric view of a first variant of a die of a tool change system according to the invention.

FIG. 15 is an axonometric view of a second variant of a die of a tool change system according to the invention.

FIG. 16 is a sectional view of a tool-holder bar of the system according to the invention supporting a punch.

FIG. 17 is an axonometric view of a first variant of a punch of a tool change system according to the invention.

FIG. 18 is an axonometric view of a second variant of a punch of a tool change system according to the invention.

FIG. 19 is an axonometric view of a third variant of a punch of a tool change system according to the invention.

FIG. 20 is a top view of a second embodiment of a tool change system according to the invention.

### BEST MODE OF CARRYING OUT THE INVENTION

With particular reference to the above figures, reference numeral 10 collectively indicates a tool change system in bending presses globally indicated with reference numeral 20.

A bending press 20 comprises a fixed frame 21 provided with supports on the ground.

The fixed frame 21 comprises, for example, a front wall, which defines an introduction mouth of a sheet to be bent, and two side walls extending rearwardly of the front wall.

The user places himself at the front of the front wall and introduces the sheet through the inlet mouth for bending the same.

The area behind the front wall is substantially inaccessible to the user and defines a substantially free space, occupied as will be described below by various components of the system 10.

The bending press 20 comprises an upper table 22 and an opposed lower table 23 of which at least one, in the example the upper table 22, is movable downwards and upwards in approaching and/or moving away from the other. The upper table 22 and the lower table 23 constitute in fact the front wall of the bending press 20.

At the lower end of the upper table 22 there is an upper vice 220, for example pneumatically operated, for removably supporting one or more single bending tools 30 and at the upper end of the lower table 23, a lower vice 230 is provided, for example pneumatically operated, for removably supporting one or more single bending tools 30.

Between the upper vice 220 and the lower vice 230, the inlet mouth for the sheet to be bent is defined.

The upper vice 220 and the lower vice 230 each have jaws defining a longitudinal (fully developed) groove having a longitudinal axis A (horizontal and parallel to each other), which defines the longitudinal axis of the bending press 20 (i.e. the bending axis given by the bending press 20 to a sheet to be bent).

In each longitudinal groove, one or more bending tools 30 can be inserted side by side (spaced apart or adjacent) with respect to a longitudinal direction parallel to the longitudinal axis A of the respective longitudinal groove.

The system 10 comprises a plurality of bending tools 30 (see FIGS. 14-15 and FIGS. 17-19 for details).

The bending tools 30 are of two distinct types.

A first type (see FIGS. 14-15) of bending tools 30 comprises a die 31, which is intended to be associated with the lower table 23 of the bending press 20, or with the lower vice 230 thereof.

The bending tools 30 comprise one or more dies 31.

Each die 31 comprises, at its upper end, a bending head 310, for example shaped like a cradle facing upwards.

The cradle has a longitudinal axis parallel to the longitudinal axis A of the longitudinal groove of the lower vice 230.

The cradle is fully developed, i.e. it has a length equal to the length of the die 31.

Each die 31 comprises, at its lower end, a gripping shank 311, which is configured to be inserted in the lower vice 230 of the bending press 20 and be held therein by a vice.

The gripping shank 311 of the die 31 is substantially prismatic and rigid.

The gripping shank 311 has a longitudinal axis parallel to the longitudinal axis A of the longitudinal groove of the lower vice 230.

The gripping shank 311 is fully developed, i.e. it has a length equal to the length of the die 31.

For example, the gripping shank 311 of the die 31 is substantially monolithic (without buttons or moving parts) and, for example, made integrally with the die itself.

Each die 31, for example at an intermediate zone—vertically interposed between the lower end and the upper end -, comprises at least one hook appendix 312 distinct from the gripping shank 311, which projects laterally with respect to the die 31, for example it projects from a front or rear wall of the die 31 (i.e. a wall of the die 31 not crossed/intercepted by the longitudinal axis thereof).

The hook appendix 312 is for example shaped like a hook with a concavity facing away from the concavity of the cradle, or downwards.

The hook appendix 312 defines a lower support surface opposed to the bending head 310, that is, facing the same side of the gripping shank 311.

The hook appendix 312 is rigidly fixed to the die 31, i.e. to the monolithic body which constitutes the die 31, for example by means of a threaded connection.

The hook appendix 312 is constrained (without possibility of moving) to the die 31.

The die 31 may have only one hook appendix 312 (of smaller longitudinal dimensions with respect to the longitudinal dimensions of the die 31 or fully developed) or 2 or more hook appendices 312 aligned with each other along an alignment direction parallel to the longitudinal axis of the die 31 (or the cradle thereof).

For example, the support surfaces of the various hook appendices 312 are all coplanar.

In the example shown in FIG. 14, the die 31 has a reduced longitudinal development and has a single hook appendix 312, in the example shown in FIG. 15, the die 31 has a large longitudinal development and has two (or more) hook appendices 312.

The hook appendices 312 are arranged on the same front wall of the die, for example at only one of the same.

A second type (see FIGS. 17-19) of bending tools 30 comprises a punch 32, which is intended to be associated with the upper table 22 of the bending press 20, for example to the upper vice 220 thereof.

The bending tools 30 comprise one or more punches 32.

Each punch 32 comprises at its lower end a bending head 320, for example shaped like a blade (whose shape/concavity may vary according to the type of bend to be imparted to the sheet metal).

The blade has an edge having a longitudinal axis parallel to the longitudinal axis A of the longitudinal groove of the upper vice 220.

The blade is fully developed, i.e. it has a length equal to the length of the punch 32.

Each punch 32 comprises, at its upper end, a gripping shank 321, which is configured to be inserted in the upper vice 220 of the bending press 20 and be held therein by a vice.

The gripping shank 321 of the punch 32 is substantially prismatic and rigid.

For example, the gripping shank 321 of the punch 32 comprises on one or both the front walls a full-development (V) indentation which is designed to be engaged by a locking tooth provided in the upper vice 220 (as known to the man skilled in the art) that, once activated, blocks the punch 32 in safety. The gripping shank 321of the punch 32 has a longitudinal axis parallel to the longitudinal axis A of the longitudinal groove of the upper vice 220.

The gripping shank 311 is fully developed, i.e. it has a length equal to the length of the punch 32.

For example, the gripping shank 321 of the punch 32 and the punch 32 is substantially monolithic (without buttons or moving parts).

Each punch 32, for example at an intermediate zone—vertically interposed between the lower end and the upper end—, comprises at least one hook appendix 322 distinct from the gripping shank 321, which projects laterally with respect to the punch 32, for example it projects from a front or rear wall of the punch 32 (i.e. a wall of the punch 32 not crossed/intercepted by the longitudinal axis thereof).

The hook appendix 322 of the punch 32 is for example shaped like a hook with a concavity facing away from the tip of the blade, or downwards.

The hook appendix 322 of the punch 32 defines a lower support surface opposed to the bending head 320, that is, facing the same side of the gripping shank 321.

The hook appendix 322 of the punch is rigidly fixed to the punch 32, i.e. to the monolithic body which constitutes the punch 31 itself, for example by means of a threaded connection.

The hook appendix 322 is constrained (without possibility of moving) to the punch 32.

The punch 32 may have only one hook appendix 322 (of smaller longitudinal dimensions with respect to the longitudinal dimensions of the punch 32 or fully developed) or 2 or more hook appendices 322 aligned with each other along an alignment direction parallel to the longitudinal axis of the punch 32 (or the blade thereof).

For example, the support surfaces of the various hook appendices 322 of the punch are all coplanar.

In the example shown in FIG. 17, the punch 32 has a reduced longitudinal development and has a single hook appendix 322, in the example shown in FIG. 19, the punch 32 has a large longitudinal development and has two (or more) hook appendices 322, in the embodiment shown in FIG. 18, the punch 32 has a longitudinal intermediate development between those previously illustrated and has two (or more) hook appendices 322.

One or more hook appendices 322 are arranged on the same front wall of the punch 32, for example only at one of the same or, preferably, both the front walls (front and rear) thereof (in a symmetrical position with respect to a median longitudinal plane of the gripping shank 321).

The system 10 comprises a storage magazine 40 adapted to support a plurality of bending tools 30 as described above.

The storage magazine 40 comprises at least one rack 41 which is provided with at least one shelf 42 on which one or more bending tools 30 are intended to rest.

For example, the shelf 42 is supported by a fixed frame defining the rack 41 so as to face the free space behind the bending press 20 and be accessible from the inside of said free space.

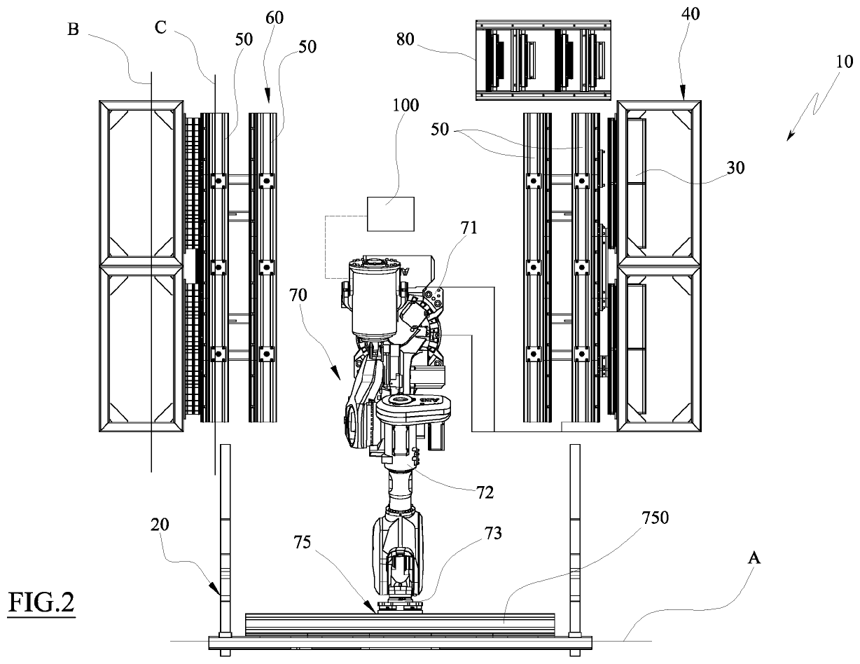

The shelf 42 is defined by a longitudinal beam with a shaped section. The shelf 42 comprises at least one longitudinal (fully developed) channel having a longitudinal axis B (see FIG. 2).

The shelf 42 can comprise several parallel longitudinal channels.

Each longitudinal channel is configured so as to be connected to one or more hook appendices 312, 322 of one or more bending tools 30, for example several bending tools 30 mutually side by side (spaced or adjacent) with respect to a longitudinal direction parallel to the longitudinal axis B of the respective longitudinal channel.

Each longitudinal channel has a concavity directed mainly upwards. In practice, the shelf 42 is designed to support one or more bending tools 30 in support and/or in suspension on the hook appendices 312, 322 thereof.

In practice, between the longitudinal channel of the shelf 42 and each hook appendix 312, 322 of each bending tool 30 a constraint is defined in such a shape as to allow the steady support of the bending tool 30 on the shelf 42 with the concavity of the hook appendix 312, 322 complementary to the concavity of the longitudinal channel of the shelf 42.

In practice, when a die 31 is resting on the shelf 42, the gripping shank 311 thereof is substantially facing downwards and the bending head 310 upwards, i.e. the bending head 310 is placed at a greater height than the gripping shank 311.

When a punch 32 is resting on the shelf 42, the gripping shank 321 thereof is substantially facing upwards and the bending head 320 downwards, i.e. the bending head 320 is placed at a lower level with respect to the gripping shank 311.

The shelf 42 (or each longitudinal channel thereof) has a substantially horizontal longitudinal axis B but is, for example, rotated with respect to a horizontal plane so as to orient the bending tools 30 supported thereby in an inclined position in which the upper ends (that is, the bending head 310 of the die 31 or the gripping shank 321 of the punch 32) are misaligned in plan with respect to the lower ends (i.e. the gripping shank 311 of the die 31 or the bending head 320 of the punch 32).

For example, in this inclined position the upper end of each bending tool 30 is adapted to project at least partially (on the same side) from the shelf 42, for example at least partially outside with respect to the overall dimensions of the rack 41 (inwards of the empty space behind the bending press 20).

The rack 41, for example, comprises a plurality of shelves 42, for example parallel to one another, for example overlapped at a suitable distance.

Moreover, the system 10 can comprise a plurality of said storage magazines 40, each provided with a rack 41 and one or more of said shelves 42.

Each storage magazine 40 is, for example, arranged behind the bending press 20, for example in the free space.

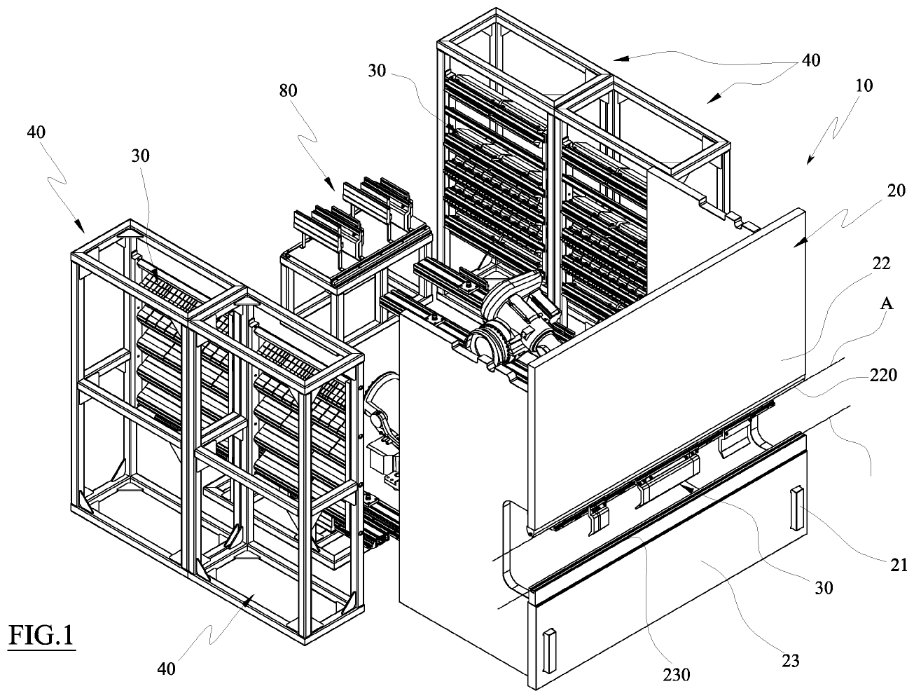

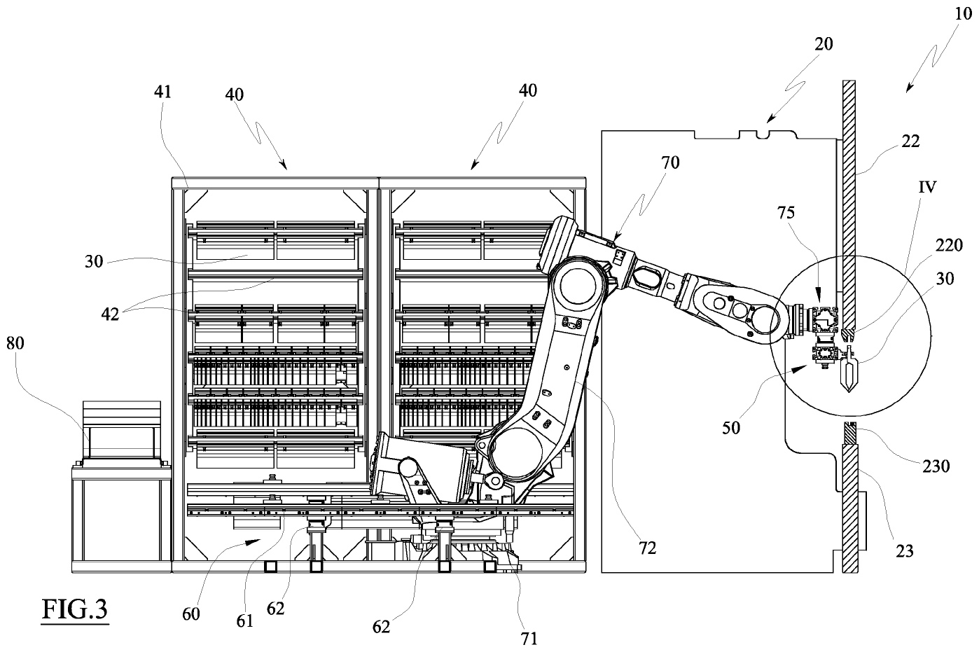

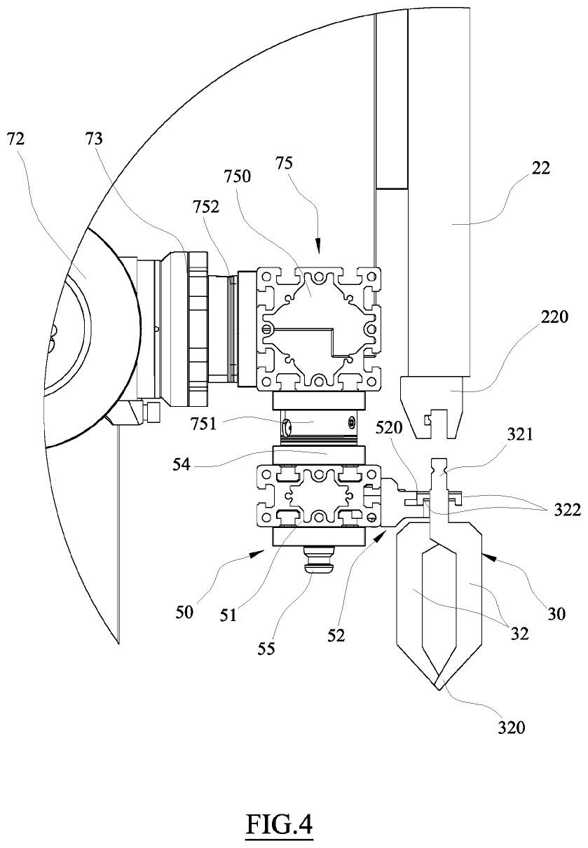

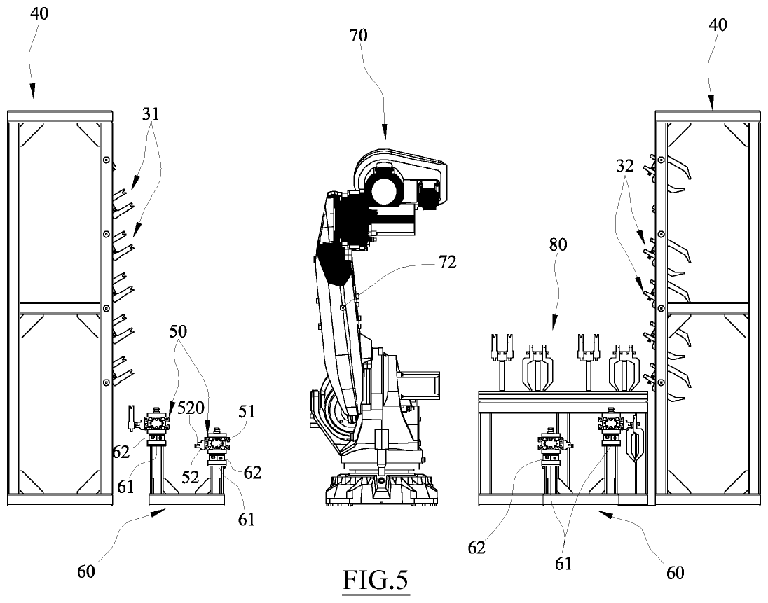

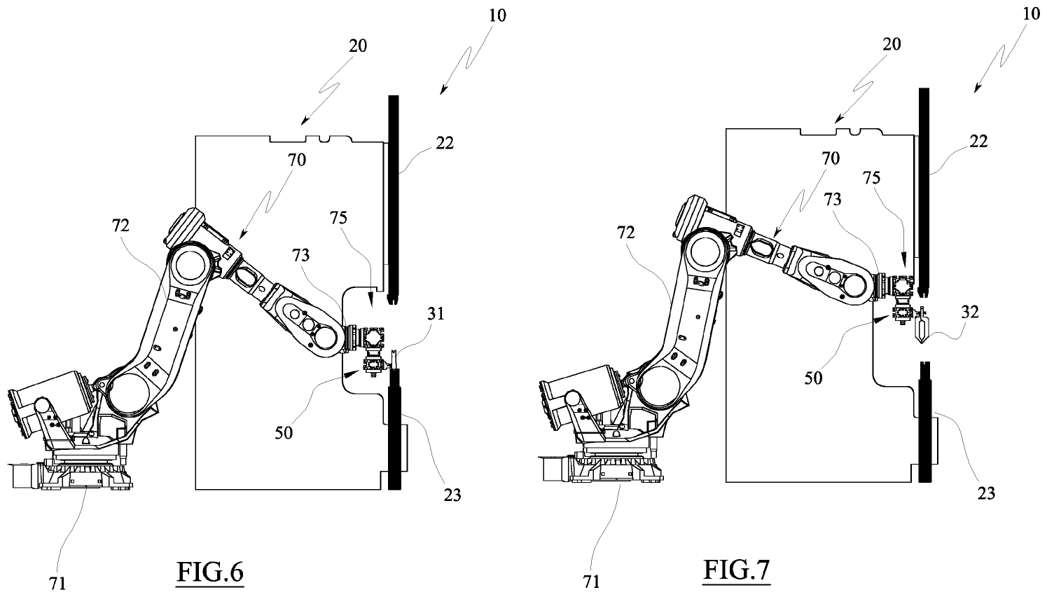

In the example shown in FIGS. 1 to 19, the longitudinal axis B of the shelves 42 of each storage magazine 40 is substantially (horizontal and) orthogonal to the longitudinal axis A of the upper vice 220 and the lower vice 230 of the bending press 20.

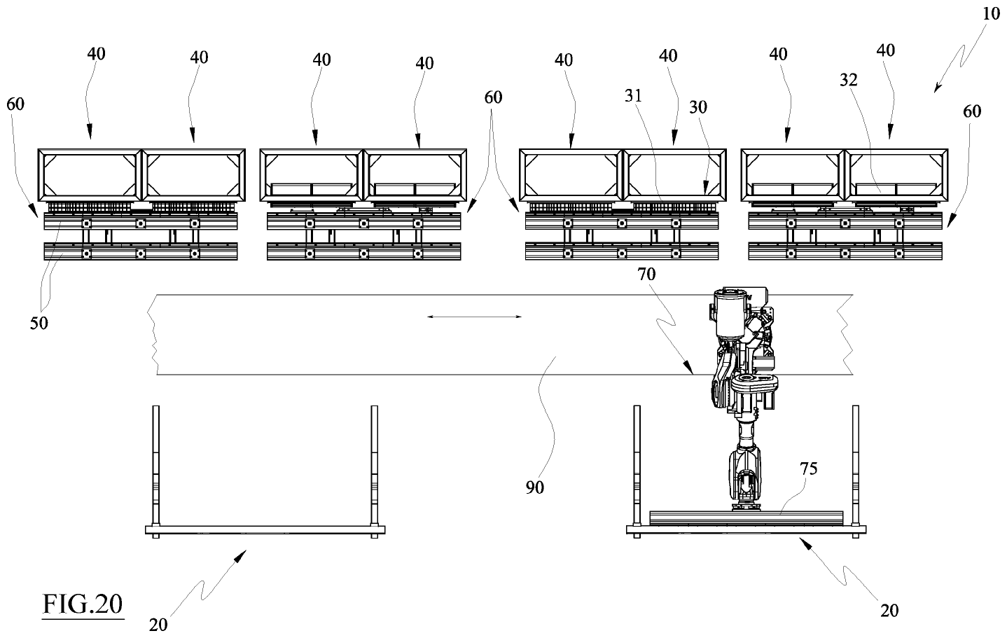

In the example shown in FIG. 20, the longitudinal axis B of the shelves 42 of each storage magazine 40 is substantially (horizontal and) parallel to the longitudinal axis A of the upper vice 220 and the lower vice 230 of the bending press 20.

For example, the system 10 comprises at least one storage magazine 40 designed to support one or more dies 31 and at least one storage magazine 40 designed to support one or more punches 32.

The system 10 comprises at least one tool-holder bar 50.

The tool-holder bar 50 is free to be moved in the free space behind the bending press 20.

The tool-holder bar 50 is a longitudinal bar having a longitudinal axis C (see FIG. 2) substantially rectilinear.

The tool-holder bar 50 is substantially rigid, i.e. is not deformable (bending) under the weight of the loads that is intended to support during operation.

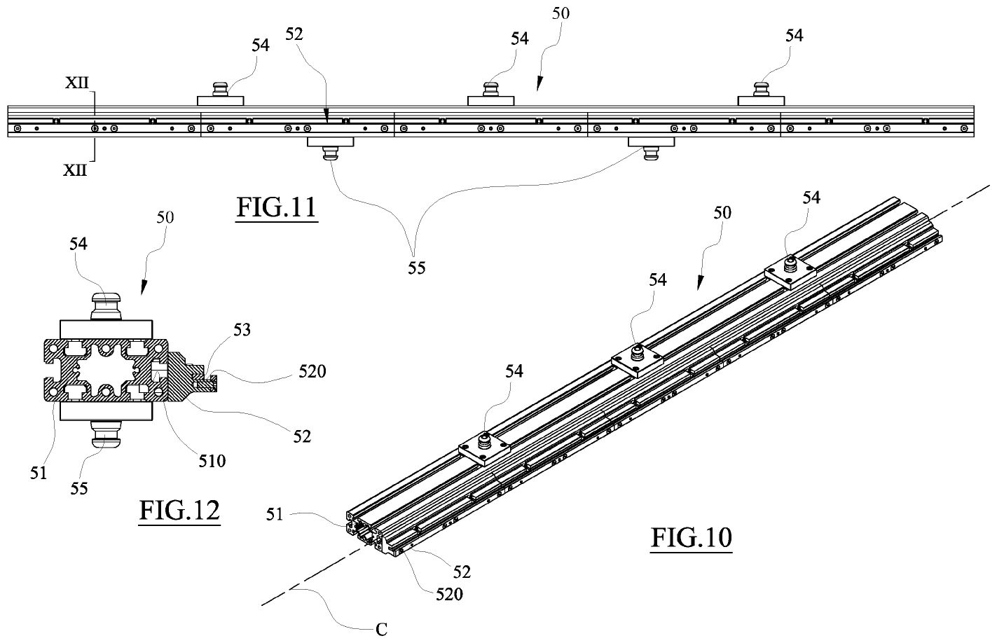

The tool-holder bar 50 (shown in detail in FIGS. 10-12) comprises a longitudinal member 51, for example hollow, provided with at least one longitudinal groove 510 (fully developed) placed on a front wall thereof (i.e. a wall not intersected by the longitudinal axis C).

The groove 510 is formed on a front vertical wall (for example on both the front vertical walls).

Further longitudinal grooves (fully developed) can be placed on a front horizontal wall thereof (for example on both front horizontal walls).

The tool-holder bar 50 comprises at least one longitudinal shelf 52 (fully developed) having a longitudinal axis parallel to the longitudinal axis C of the tool-holder bar 50.

The longitudinal shelf 52 is rigidly fixed to the longitudinal member 51, for example at a groove 510.

In practice, the longitudinal shelf 52 comprises inserts adapted to be inserted (axially) into the groove 510, for example by means of a prismatic connection (dovetailed) and to be fixed therein axially, for example by means of threaded clamping members.

It is not excluded that the longitudinal shelf 52 may be made integrally with the longitudinal member 51.

The longitudinal channel 52 is configured so as to be connected to one or more hook appendices 312, 322 of one or more bending tools 30, for example several bending tools 30 mutually side by side (spaced or adjacent) with respect to a longitudinal direction parallel to the longitudinal axis C of the tool-holder bar.

The longitudinal shelf 52 comprises a support cradle 520 (see FIG. 12), for example, at full development, which has a concavity facing upwards.

In practice, the longitudinal shelf 52 is designed to support, by means of the support cradle 520, one or more bending tools 30 resting and/or suspended on the hook appendices 312, 322 thereof.

Each of the bending tools 30, when supported by the tool-holder bar 50 with the hook appendix/ces 312, 322 in engagement in the support cradle 520, has its own gripping shank 311, 321 with a longitudinal axis parallel to the longitudinal axis C of the tool-holder bar 50 and, in the case of several bending tools 30 on the same tool-holder bar 50, the gripping shanks 311, 321 are aligned with one another along a (single) alignment direction parallel to the longitudinal axis C of the tool-holder bar 50.

In practice, between the support cradle 520 of the longitudinal shelf 52 and each hook appendix 312, 322 of each bending tool 30 a constraint is defined in such a shape as to allow the steady support of the bending tool 30 on the shelf 42 with the concavity of the hook appendix 312, 322 complementary to the concavity of the support cradle 520 of the longitudinal shelf 52.

The weight force acting on the bending tool 30 is such as to maintain a stable balance thereof when the cradle 520 of the longitudinal shelf 52 houses the hook appendix 312, 322 of the bending tool itself.

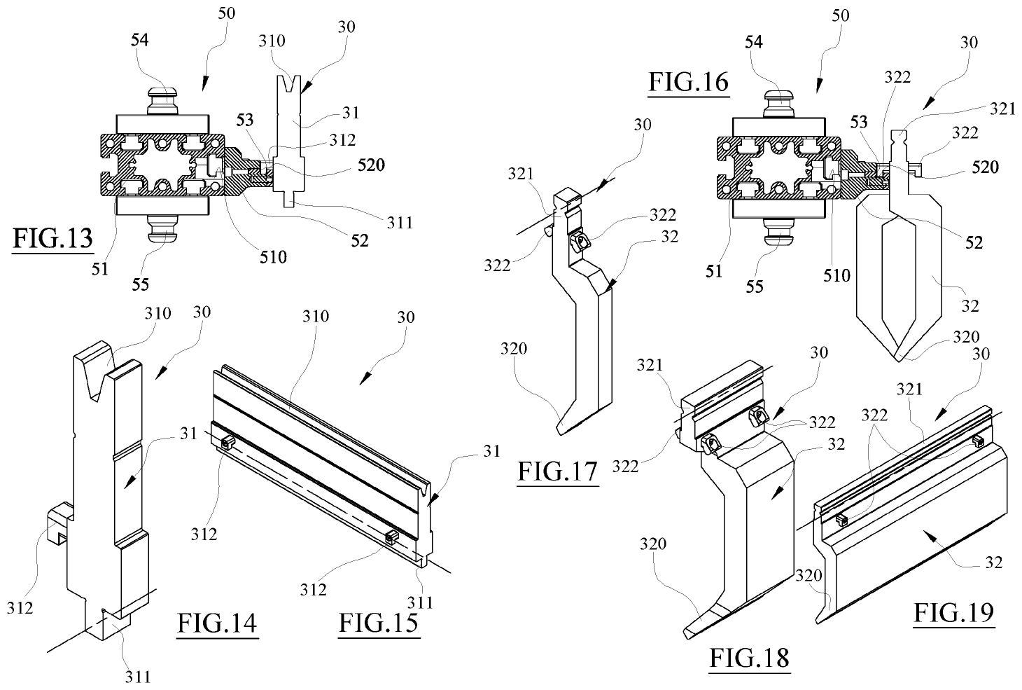

In practice, when a die 31 is resting on the longitudinal shelf 52 (see FIG. 13), the gripping shank 311 thereof is substantially facing downwards and the bending head 310 upwards, (for example aligned in plan with the gripping shank 311), i.e. the bending head 310 is placed at a greater height than the gripping shank 311.

When a punch 32 is resting on the longitudinal shelf 52 (see FIG. 16), the gripping shank 321 thereof is substantially facing upwards and the bending head 320 downwards (for example aligned in plan with the gripping shank 311), i.e. the bending head 320 is placed at a lower level with respect to the gripping shank 311.

The longitudinal shelf 52 (or the longitudinal cradle 520 thereof) has a substantially horizontal longitudinal axis and is kept substantially horizontal during the movement of the tool-holder bar 50.

The tool-holder bar 50 may have, for example, two longitudinal shelves, for example each placed at a front vertical wall (and symmetrical with respect to a longitudinal median plane of the tool-holder bar 50).

The tool-holder bar 50 may comprise a retention vice 53 configured to retain the hook appendix 312, 322 of the bending tool 30 in engagement with the longitudinal cradle 520 of the longitudinal shelf 52.

The retention vice 53 comprises a jaw which is movably associated with the longitudinal shelf 52, for example slidably with respect thereto, and configured to be selectively moved between an open configuration of the longitudinal cradle 520 and a closed configuration of the longitudinal cradle 520.

For example, the retention vice 53 is defined between a (vertical) wall of the longitudinal cradle 520 and a (vertical) wall of the jaw, which is housed inside the longitudinal cradle itself and is movable on a horizontal plane in a direction orthogonal to the longitudinal axis of the tool-holder bar 50.

In the open configuration of the retention vice 53, the jaw is distal from the opposed vertical wall of the longitudinal cradle 520 of a distance greater than the thickness of the portion of hook appendix 312, 322 intended to enter the longitudinal cradle 520 itself, thereby in the open configuration of the retention vice 53, the hook appendix 312.322 is free to enter and exit the engagement with the longitudinal cradle 520, for example by means of vertical translations (downwards or upwards respectively).

In the closed configuration of the retention vice 53, the jaw is proximal to the opposed vertical wall of the longitudinal cradle 520 by a distance equal to the thickness of the portion of hook appendix 312, 322 intended to enter the longitudinal cradle 520 itself, thus in the closed configuration of the retention vice 53, the hook appendix 312, 322 is in engagement with the longitudinal cradle 520 clamped by the retention vice 53 and the escape (also accidental) from the longitudinal cradle 520 is substantially prevented.

The retaining vice 53 is selectively operable between the open configuration and the closed configuration, for example by thrust means.

For example, the thrust means may be pneumatic (bidirectional) means, for example supplied by a pneumatic circuit located inside the longitudinal bar 50 (which will be described further below), for example this pneumatic circuit exploits the internal cavity of the longitudinal member 51, or of a mechanical type, for example by using one or more springs which push the retention vice 53 towards the closed position, or of a magnetic type (bidirectional) or other known type.

The tool-holder bar 50 comprises at least one clamping member 54, for example positioned above the tool-holder bar 50.

For example, the tool-holder bar 50 comprises a plurality (in number of 3) of gripping members 54, for example mutually (equally) spaced and distributed along the longitudinal axis C of the tool-holder bar 50.

For example, each gripping member 54 is fixed at the upper front horizontal wall of the longitudinal member 51, for example by means of the mechanical connection with a groove or several grooves provided therein.

For example, each gripping member 54 is a (male) connector, for example a standard clamping pin, for example smoothly connected with the inner cavity of the longitudinal member 51.

The tool-holder bar 50 comprises at least one fixing member 55, for example positioned below the tool-holder bar 50.

For example, the tool-holder bar 50 comprises a plurality (in number of 2) of fixing members 55, for example mutually (equally) spaced and distributed along the longitudinal axis C of the tool-holder bar 50.

For example, each fixing member 55 is fixed at the lower front horizontal wall of the longitudinal member 51, for example by means of the mechanical connection with a groove or several grooves provided therein.

For example, each fixing member 55 is a (male) connector, for example a standard clamping pin, for example smoothly connected with the inner cavity of the longitudinal member 51.

The system 10 comprises a plurality of tool-holder bars 50 which are mutually distinct (and equal).

For example, the system 10 comprises at least one tool-holder bar 50 designed to support one or more dies 31 and at least one tool-holder bar 50 designed to support one or more punches 32.

In the example, the system 10 comprises two tool-holder bars 50 each designed to support one or more dies 31 and two tool-holder bars 50 each designed to support one or more punches 32.

The system 10 comprises a loading station 60 adapted to support at least one tool-holder bar 50 for loading bending tools 30 thereon and for unloading bending tools 30 therefrom.

The loading station 60 comprises a longitudinal support 21, for example provided with supports on the ground.

The support 61 comprises at least one longitudinal crosspiece configured to (superiorly) support a tool-holder bar 50 in support.

For example, the support 61 is configured to support a tool-holder bar 50 in such a position that the longitudinal cradle 520 thereof faces upwardly.

The support 61, that is, the longitudinal crosspiece, comprises for example one or more fixing elements 62 adapted to detachably attach the tool-holder bar 50 to the support 61.

Each fixing element 62 is configured to engage a fixing member 55 of the tool-holder bar 50 in a detachable manner.

Each fixing element 62 can be pneumatically operated and is selectively operable between a gripping configuration, in which it retains the fixing member 55, and a release configuration, in which it releases the fixing member 55 so that the tool-holder bar 50 can be detached from the support 61.

Each fixing member 62 is of the type of a (female) connector, for example a clamping cylinder, for example of a standard type.

Furthermore, each support 61 can comprise a pneumatic circuit, not shown since it is of a known type, designed to selectively operate the fixing element 62 between the gripping configuration and the release configuration.

The pneumatic circuit of the support 61, moreover, when each fixing element 62 is in gripping configuration with a respective fixing member 55, is adapted to selectively operate the retention vice 53 of the tool-holder bar 50 between the closed position thereof and the open configuration thereof.

For example, there are pneumatic channels (for example provided in the tool-holder bar 50) which place the fixing members 55 in fluid communication with the retention vice 53, i.e. the jaw thereof.

In particular, the pneumatic circuit is configured to (simultaneously) bring the fixing elements 62 in retention configuration and the retention vice 53 in the open configuration and, for example, vice versa, to (simultaneously) bring the fixing elements 62 in release configuration and the retention vice in the closed position.

For example, the support 61 comprises a plurality (for example in number of 2) of longitudinal crosspieces.

The system 10, for example, comprises a plurality of loading stations 60, for example two separate loading stations 60, one in which at least one tool-holder bar 50 is arranged to support the dies 31 (for example two tool-holder bars 50) and one in which at least a tool-holder bar 50 is arranged to support the punches 32 (for example two tool-holder bars 50).

Each loading station 60 is placed in the vicinity of one (or more) storage magazines 40, for example in an area in front of it located in the free space, i.e. a distal area from the bending press 20 and back thereto.

For example, each loading station 60 has the support 61 (i.e. the longitudinal crosspiece thereof) with a longitudinal axis parallel to the longitudinal axis C of the shelf/ves 42 of the storage magazine 40.

The system 10 comprises a robotized arm 70 which is adapted to carry out tool changes in the bending press 20.

The robotized arm 70 is positioned behind the bending press 20, i.e. in the rear free space.

The robotized arm 70 is configured so as to be able to reach, as will be better described in the following description, both the bending press 20, and each storage magazine 40, and each loading station 60 of the system 10.

The robotized arm 70 is an arm with 6 (or more) axes, that is to say, 6 (or more) degrees of freedom.

The robotized arm 70 comprises a lower base 71 resting on the ground and a plurality of articulated sections 72 according to said axes (rotational and/or translational) controlled by respective actuators as known to the man skilled in the art.

The robotized arm 70 comprises at its free end a connector 73, to which a gripping member can be associated, in a removable manner.

For example, connector 73 is a (female) connector, for example a standard clamping cylinder.

The robotized arm 70 comprises a first gripping member 74, which is configured to releasably grasp a bending tool 30, for example one at a time.

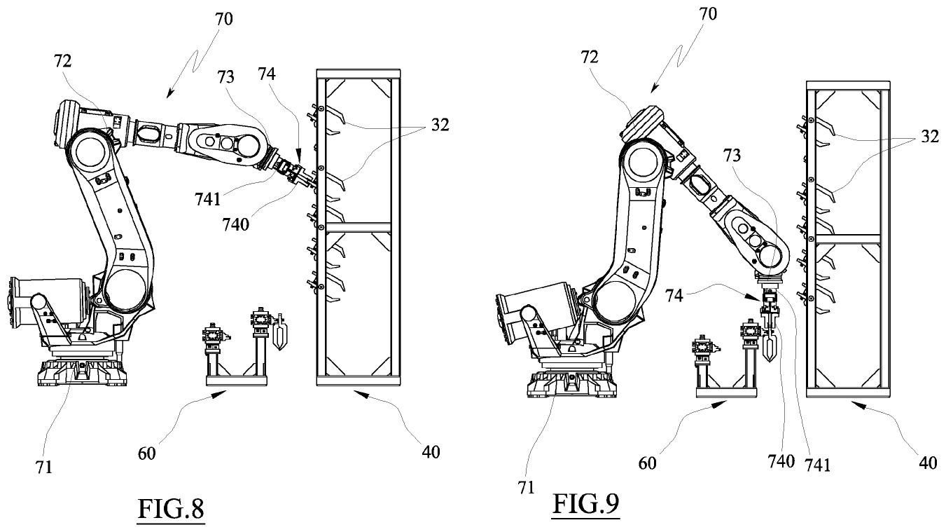

The first gripping member 74 is shown in FIGS. 8-9.

The first gripping member 74 comprises a gripper 740, for example a pneumatically operated gripper, which comprises a pair of fingers which can be opened and closed for grasping a bending tool 30.

In practice, the first gripping member 74, or the gripper 740, is selectively operable between a gripping configuration (in which the fingers are closed/clamped together, thereby clamping a portion of the bending tool 30) and a release configuration (in which the fingers release the bending tool 30).

For example, the gripper 740 is configured to clamp a portion of the bending tool 30 distinct from the hook appending 311, 321 thereof.

For example, the gripper 740 is configured to clamp at least one of the gripping shank or a proximal portion of the bending head of the bending tool 30.

For example, the gripper 740 is configured to grasp (clamp) the gripping shank 321 of a punch 32 or a portion proximal to the bending head 310 of a die 31.

The first gripping member 74 comprises an attachment body 741 configured to be connected in a detachable manner to the connector 73 of the robotized arm, for example automatically.

The attachment body 741 is, for example, of the (male) connector type, for example a clamping pin, for example of a standard type.

The first gripping member 741 may be of different sizes depending on the size of the bending tool 30 to be grasped.

The robotized arm 70 comprises a second gripping member 75 which is configured to releasably grasp a tool-holder bar 50, for example one at a time.

The second gripping member 75 is shown in FIGS. 2-4 and 6-7.

The second gripping member 75 comprises a longitudinal section bar 750, for example internally hollow, having a longitudinal axis (see FIG. 2) substantially rectilinear.

The longitudinal section bar 750 is substantially rigid, i.e. is not deformable (bending) under the weight of the loads that is intended to support during operation.

The longitudinal section bar 750 comprises at least one gripping element 751, for example positioned below the longitudinal section bar 750.

The gripping element 751 is configured to releasably constrain a gripping member 54 of the tool-holder bar 50.

For example, the longitudinal section bar 750 comprises a plurality (in number of 3) of gripping elements 751, for example mutually (equally) spaced and distributed along the longitudinal axis of the longitudinal section bar 750.

For example, each gripping element 751 is fixed at the lower wall of the longitudinal section bar 750, for example by mechanical connection with a groove or several grooves therein provided.

The second gripping member 75, i.e. each gripping element 751, for example is pneumatically operated, and is selectively operable between a gripping configuration, in which it retains a tool-holder bar 50, and a release configuration, in which it releases a tool-holder bar 50.

In particular, the gripping members 751, at the same time, can be operated between the respective gripping configuration, in which each of them retains a gripping member 54 of the tool-holder bar 50 so that the tool-holder bar 50 can be rigidly constrained (integrally) to the second gripping member 75, and the respective release configuration, in which each of them releases the gripping member 54 of the tool-holder bar 50 so that the tool-holder bar 50 can be detached/released from the second gripping member 75.

For example, when the tool-holder bar 50 is grasped by the second gripping member 75, the longitudinal axis C of the tool-holder bar 50 is parallel to the longitudinal axis of the longitudinal member 750 of the second gripping member 75.

Moreover, when the tool-holder bar 50 is grasped by the second gripping member 75, the second gripping member 75 is substantially overlapped in plan to the tool-holder bar 50.

For example, each gripping element 751 is a (female) connector, for example a standard clamping cylinder, for example smoothly connected with the inner cavity of the longitudinal section bar 750.

The second gripping member 75 comprises an attachment body 752 configured to be connected in a detachable manner to the connector 73 of the robotized arm 70, for example automatically.

The attachment body 752 is fixed at a front (rear) wall of the longitudinal section bar 750, adjacent to the lower wall, for example by mechanical connection with a groove or several grooves provided therein.

The attachment body 752 is for example placed at a median plane orthogonal to the longitudinal axis of the longitudinal section bar 750.

The attachment body 752 is, for example, of the (male) connector type, for example a clamping pin, for example of a standard type.

Furthermore, the robotized arm 70 may comprise a pneumatic circuit, not shown as being of a known type, designed to selectively operate each gripping member 74, 75 between the gripping configuration thereof and the release configuration thereof.

When the robotized arm 70 is connected to the second gripping member 75 and this is in the gripping configuration of a tool-holder bar 50, the pneumatic circuit of the robotized arm 70 is adapted to selectively operate the retention vice 53 of the tool-holder bar 50 between the closing position thereof and the open configuration thereof.

For example, the pneumatic circuit has pneumatic channels (for example provided in the longitudinal section bar and in the tool-holder bar 50) place the gripping elements 751 in fluid communication with the retention vice 53, i.e. the jaw thereof.

In particular, the pneumatic circuit is configured to (simultaneously) bring the gripping elements 751 in grasping configuration and the retention vice 53 in the closed position and for example to bring the retention vice 53 in the open configuration while maintaining the gripping elements 751 in grasping configuration.

For example, the first gripping member 74 and the second gripping member 75 can be selectively positioned, when not engaged by the robotized arm 70, in a respective storage area, for example positioned behind the bending press 20, or reachable from the robotized arm 70.

For example, the storage area is positioned at a storage magazine 40, for example at or in place of a shelf 42.

The system 10 further comprises a supply/replacement area 80 of bending tools 30 to be loaded into the storage magazine 40 thereof.

For example, the supply/replacement area 80 positioned behind the bending press 20, that is to say, reachable by the robotized arm 70, for example perpendicular to a storage magazine 40.

In the supply/replacement area 80 one or more bending tools 30 can be arranged, resting on the respective hook appendices 312, 322, for example resting on a movable trolley.

In practice, the bending tools 30 are positioned in the supply/replacement area 80 so as to be able to be grasped by the robotized arm 70, i.e. by the first gripping member 74 thereof, as described above and carried by the robotized arm resting on a shelf 42 of the storage magazine 40 or directly resting on a tool-holder bar 50 located at a loading station 60.

For example, the system 10 is confined inside a fencing or safety cage (not shown) which prevents access to the back space of the bending press 20, or to the operating space of the robotized arm 70, when this is in operation.

For example, the movable trolley of the supply/replacement area 80 is movable through a secure access opening (not shown) provided in the cage for the secure access of bending tools 30 therein.

The system 10, as shown in the embodiment shown in FIG. 20, can be connected to more than one bending press 20, for example to multiple bending presses side by side and aligned along a side-by-side direction parallel to the longitudinal axis A of the bending presses 20.

In this case, for example, the system 10 could comprise a single robotized arm 70, which is movable along the side-by-side direction, for example by means of a conveyor 90, for example a track motion, so as to move selectively behind each bending press 20.

In this case, for example, the storage magazines 40 are all aligned and side by side with the longitudinal axis 40 of the shelves 42 parallel to the above axis, as well as the loading stations 60.

For example, the system 10 can be supported by a platform, for example a movable platform and/or contained within a contained space, for example inside a container (of standard dimensions).

The system 10 further comprises an electronic control unit 100 (see FIG. 2) operatively connected to the robotized arm 70 and/or the gripping members 74, 75 for controlling the operation steps thereof, as will be better described below.

The electronic control unit 100 is, for example, a processor (or microprocessor) provided with memory means in which data and programs are stored for operating the control and operation steps of the robotized arm 70.

The electronic control unit 100 can also be operatively connected to the bending press 20 for controlling and commanding the operation thereof, for example for opening and closing the upper vice 220 and/or lower vice 230.

In particular, the electronic control unit 100 is configured to perform (command and control) a first loading/unloading step of a bending tool 30 at a time on/from the tool-holder bar 50.

To do so, first, the electronic control unit 100 is configured to control the robotized arm 70 so as to connect the first gripping member 74 to the connector 73.

For example, this first loading/unloading step provides for a first loading step of the tool-holder bar 50.

The first loading step of the tool-holder bar 50 provides that, with a tool-holder bar 50 in a loading station 60, for example in a gripping configuration, or with the retention vice 53 (where provided) in the open configuration, the robotized arm 70 can grasp (FIG. 8) a bending tool 30 (at a time) from a storage magazine 40, for example a specific bending tool 30 which is in a predetermined position of the storage magazine 40, and can position it (FIG. 9) in a predetermined axial position of the tool-holder bar 50, or hooks the hook appendix/ces 312, 322 of the bending tool 30 taken to the longitudinal shelf 52 leaving it resting on the tool-holder bar 50.

This first loading step can be repeated for a desired number of times equal to the number of bending tools 30 (of the same type, i.e. all punches 32 or all dies 31) which must be retained by the tool-holder bar 50.

The bending tools 30 are positioned along the tool-holder bar 50 according to a predefined installation scheme which will be the one intended to be used by the bending press 20 in a suitable working step thereof.

When a bending tool 30 must be replaced or removed in a tool-holder bar 50, the electronic control unit 100 is configured to perform a second unloading step of the tool-holder bar 50 provided for in the above first loading/unloading step.

The second unloading step of the tool-holder bar 50 provides that, with a tool-holder bar 50 in a loading station 60, for example in a gripping configuration, or with the retention vice 53 (where provided) in the open configuration, the robotized arm 70 can grasp (FIG. 9) a bending tool 30 (at a time) from an axial position of the tool-holder bar 50, or hook the hook appendix/ces 312, 322 of the bending tool 30 which is resting on the tool-holder bar 50, and can position it (FIG. 8) in a predefined storage position in a storage magazine 40.

This second unloading step can be repeated for a desired number of times equal to the number of bending tools 30 (of the same type, i.e. all punches 32 or all dies 31) which must be removed from the tool-holder bar 50.

Each first loading step and each second unloading step preferably, but not limitedly, are carried out while the bending press 20 is working, i.e. is operative in the bending of sheets with a different or homologous set of bending tools 30 fixed to the respective upper vice 220 and lower vice 230. In practice, the loading and unloading activities (filling and emptying or replacement) of the folding tools 30 on the respective tool-holder bars 50 are performed by the system 10 in a masked time, i.e. a working time of the bending press 20, in which the bending press 20 is not stationary and can work with an additional set of bending tools.

When the set of bending tools 30 (the punches 32 and/or the dies) used in the bending press 20 must be replaced with a new set, this new set is already arranged on the tool-holder bar 50 (placed in the loading station 60), ready for tool change.

In fact, when a tool-holder bar 50 is filled with bending tools 30 positioned according to a desired installation scheme such as to be used by the bending press 20 and a set of bending tools 30 is used in the bending press 20, for example it is clamped by the jaws of the upper vice 220 or by the jaws of the lower vice 230 thereof, it is possible to operate the system so as to change the set of bending tools 30 used in the bending press 20 with a set of bending tools 30 with which the tool-holder bar 50 is filled.

To do so, the electronic control unit 100 is configured to perform a second step for gripping and moving the tool-holder bar 50.

Firstly, the system 10 provides for removing the complete set of bending tools 30 possibly used in the bending press 20, that is the whole set of punches 32 or the whole set of dies 31.

To do so, first, the electronic control unit 100 is configured to control the robotized arm 70 so as to connect the second gripping member 75 to the connector 73.

The second gripping and moving step therefore provides a first gripping step of a tool-holder bar 50, for example an empty tool-holder bar 50 (without bending tools 30) from a loading station 60, for example by grasping the same by the second gripping member 75.

Once the empty tool-holder bar 50 has been taken, the second gripping and moving step provides for the movement of the tool-holder bar 50 taken from a loading/unloading position thereof, in which the tool-holder bar 50 is arranged in the loading station 60 at a supply position of the bending press 20, in which the tool-holder bar 50 is arranged near the bending press 20 with a longitudinal axis C parallel to a longitudinal axis A of the bending press 20, for grasping the entire set of bending tools 30, or else of dies 31 or punches 32, from the bending press 20, i.e. the lower vice 230 or the upper vice 220, respectively.

For example, the movement of the tool-holder bar 50 is such as to always maintain the tool-holder bar 50 horizontal.

In the supply position, the tool-holder bar 50 has the support cradle 520 vertically aligned to the hook appendices 312, 322 of each bending tool 30 of the set of punches 32 or dies 31 to be removed from the bending press.

Furthermore, in the supply position the tool-holder bar 50 carries the support cradle 520 so as to be engaged by each of the hook appendices 312, 322 of each bending tool 30 of the set of punches 32 or dies 31 to be removed.

For example, during the movement step (with the tool-holder bar 50 empty), the retention vice 53 is kept in the open configuration, when the support cradle 520 is engaged by each of the hook appendices 312, 322 it is possible that the electronic control unit 100 brings the retention vice 53 in the closed configuration.

Subsequently, it is possible to control the upper vice 230 or the lower vice 220 of the bending press 20 so that it opens and releases all the respective set of punches 32 or dies 31 to be removed from the bending press 20.

In this way, the tool-holder bar 50 which was previously empty has been filled with bending tools 30 to be replaced.

This tool-holder bar 50 is still gripped by the robotized arm 70, which is controlled by the electronic control unit 100 for moving the tool-holder bar 50 from the supply position to the loading/unloading position where the tool-holder bar 50 is released by the second gripping member 75 resting on a loading station 60.

The second gripping and moving step provides at this point a second gripping step of a tool-holder bar 50, for example a filled tool-holder bar 50 (in which—as described above—a set of bending tools 30 which replaces the set removed, is loaded) from a loading station 60, for example by grasping the same by the second gripping member 75.

Once the full tool-holder bar 50 has been taken, the second gripping and moving step provides for the movement of the tool-holder bar 50 taken from the loading/unloading position thereof, to the supply position of the bending press 20, for releasing the entire set of bending tools 30, or else of dies 31 or punches 32, to the bending press 20, i.e. the lower vice 230 or the upper vice 220, respectively.

For example, the movement of the tool-holder bar 50 is such as to always maintain the tool-holder bar 50 horizontal.

In the supply position, the gripping shanks 311, 321 of all bending tools 30 which fill the tool-holder bar 50 are aligned vertically with respect to the longitudinal groove of the upper vice 230 or of the lower vice 220 of the bending press 20 to which the bending tools 30 must be released.

Moreover, in the supply position the tool-holder bar 50 carries the gripping shanks 311, 321 inside the longitudinal groove of the upper vice 230 or the lower vice 220 of the bending press 20 to which the bending tools 30 must be released.

At this point, it is possible to control the upper vice 230 or the lower vice 220 of the bending press 20 so that all the respective set of punches 32 or dies 31 just supplied to the bending press 20 by the robotized arm 70 are closed and retained.

In particular, the electronic control unit 100 is configured to control the robotized arm 70 and/or the retention vice 53 of the tool-holder bar 50, so as to release the bending tools 30 supported by the tool-holder bar 50 deliver them to the upper vice 230 or the lower vice 220 of the bending press 20) only after the upper vice 230 or the lower vice 220 of the bending press 20 are closed so as to safely retain and lock the respective bending tools 30.

For example, during the handling step (with the tool-holder bar 50 full), the retention vice 53 is maintained in the closed configuration, when the gripping shanks 311, 321 are secured inside the longitudinal groove of the upper vice 230 or of the lower vice 220 (closed) of the bending press 20 to which the bending tools 30 must be released, it is possible that the electronic control unit 100 carries the retention vice 53 to the open configuration for releasing the bending tools into the bending press 20.

In this way, the tool-holder bar 50 which was previously full has been emptied of all the bending tools 30 which it has replaced in the bending press 20.

This tool-holder bar 50 now empty is still gripped by the robotized arm 70, which is controlled by the electronic control unit 100 for moving the tool-holder bar 50 from the supply position to the loading/unloading position where the empty tool-holder bar 50 is released by the second gripping member 75 resting on a loading station 60 for a new filling.

This operating cycle can be repeated for any set of bending tools 30 which must be loaded, removed or replaced by the bending press 20.

Several changes and variations may be made to the invention thus conceived, all falling within the scope of the inventive concept.

Moreover, all details can be replaced with other technically equivalent elements.

In practice, the materials used as well as the shapes and sizes may be any according to the requirements, without departing from the protection scope of the following claims.

1. System (10) for tool changing in bending presses (20), the system (10) comprising:
a plurality of bending tools (30) each having a gripping shank (311, 321) configured to be clamped by a bending press (20) and a hook appendix (312,322) distinct from the gripping shank (311,321);
a tool-holder bar (50) configured to sustain in a detachable way at least one bending tool (30) by means of the hook appendix (312, 322); and
a robotized arm (70) configured to selectively grasp and move the at least one bending tool (30), for loading/unloading a bending tool (30) on/from the tool-holder bar (50), and the tool-holder bar (50), for moving the tool-holder bar (50) nearer to/away from the bending press (20).

2. The system (10) according to claim 1, wherein the robotized arm (70) comprises a first gripping part (74) configured to grasp the at least one bending tool (30) at a portion (310, 321) of the same distinct from said hook appendix (312, 322).

3. The system (10) according to claim 1, wherein the robotized arm (70) comprises a second gripping part (75) configured to grasp the tool-holder bar (50).

4. The system (10) according to claim 1, wherein the tool-holder bar (50) comprises a retention vice (53) configured to retain the hook appendix (312, 322) of the bending tool (30), wherein the retention vice (53) is selectively operable between an opening configuration, wherein the retention device (53) frees the hook appendix (312, 322), and a closing configuration, wherein the retention device (53) retains the hook appendix (312, 322).

5. The system (10) according to claim 4, wherein the retention vice (53) of the tool-holder bar (50) is alternately operable between the opening configuration and the closing configuration by the robotized arm (70), when the robotized arm (70) is engaged on the tool-holder bar (50).

6. The system (10) according to claim 1, wherein the tool-holder bar (50) is configured to sustain in a detachable way a plurality of bending tools (30) with the gripping shanks (311, 321) aligned with one another along a longitudinal axis (C) of the tool-holder bar (50) and the hook appendices (312, 322) aligned with one another along the longitudinal axis (C) of the tool-holder bar (50).

7. The system (10) according to claim 1, wherein the at least one bending tool (30) is a plurality of bending tools (30) and wherein the robotized arm (70) is operatively connected to an electronic control unit (100) configured to perform the following steps:
a first step of loading/unloading one bending tool (30) at a time on/from the tool-holder bar (50); and
a second step of grasping and moving the tool-holder bar (50).

8. The system (10) according to claim 7, wherein the first step comprises a step of loading the bending tool (30) comprising the steps of:
picking up one bending tool (30) at a time from a storage magazine (40) of the plurality of bending tools (30);
positioning the bending tool (30) picked up at a pre-determined axial position of the tool-holder bar (50); and
releasing the bending tool (30) on the tool-holder bar (50) by means of the mechanical engagement of the hook appendix (312, 322) with the tool-holder bar (50).

9. The system (10) according to claim 7, wherein the first step comprises a step of unloading the bending tool (30) comprising the steps of:
picking up one bending tool (30) at a time from a pre-determined axial position of the tool-holder bar (50);
positioning the bending tool (30) picked up at a pre-determined position of a storage magazine (40) of the plurality of bending tools (30); and
releasing the bending tool (30) in the storage magazine (40).

10. The system (10) according to claim 7, wherein the second step comprises the steps of:
grasping the tool-holder bar (50); and
moving the tool-holder bar (50) grasped between a loading/unloading position thereof, wherein the tool-holder bar (50) is arranged in a loading station (60) distal from the bending press (20), and a supply position of the bending press (20), wherein the tool-holder bar (50) is arranged in the proximity of the bending press (20) with longitudinal axis (C) parallel to a longitudinal axis (A) of the bending press (20) itself for the picking up/release of bending tools (30) from/to the bending press (20).

11. The system (10) according to claim 7, wherein the first loading/unloading step is completely performed during a work step of the bending press (20), wherein the bending press (20) bends by means of a further bending tool (30) clamped by the bending press (20).

12. The system (10) according to claim 1, wherein the robotized arm (70) is placed on a conveyor (90) so the robotized arm (70) can be displaced by the conveyor (90) alternately among a plurality of bending presses (20).

13. (canceled)
